(19) United States
(12) Patent Application Publication
(10) Pub. No.: US 2025/0298237 A1
(43) Pub. Date: Sep. 25, 2025

(54) SYSTEM, METHOD, AND APPARATUS FOR DE-CENTERED STEERING FOR AN ELECTRO-MAGNETIC BEAM WITH SOURCE STEERING

(71) Applicant: Exciting Technology LLC, Dayton, OH (US)

(72) Inventors: Paul F. McManamon, Dayton, OH (US); Abtin Ataei, Oakwood, OH (US)

(21) Appl. No.: 19/231,936

(22) Filed: Jun. 9, 2025

Related U.S. Application Data
(63) Continuation of application No. PCT/US2023/083360, filed on Dec. 11, 2023.
(60) Provisional application No. 63/431,544, filed on Dec. 9, 2022.
(60) Provisional application No. 63/432,503, filed on Dec. 14, 2022.
(60) Provisional application No. 63/447,814, filed on Feb. 23, 2023.

(51) Int. Cl. G02B 26/10; G02B 13/00; G02B 13/22; G02B 26/08; G02B 27/09; G02B 27/30

(52) U.S. Cl. CPC G02B 26/101; G02B 13/0005; G02B 13/22; G02B 26/0875; G02B 27/0905; G02B 27/0955; G02B 27/30

(57) ABSTRACT

A device may include a fixed fiber. A device may include a moveable lens, wherein the fixed fiber and the moveable lens are configured to generate a cone of light. A device may include a light cone collimator/deflector (LCCD) comprising: a plurality of lenses, one of the plurality of lenses being downstream of other ones of the plurality of lenses, the one of the plurality of lenses comprising an exit aperture configured to be filled by steered light, such that a steering beam is output at the exit aperture.

### CROSS-REFERENCE TO RELATED APPLICATIONS

The present application claims priority to and is a continuation of International Application No. No. PCT/US2023/083360, filed 11 Dec. 2023, published as WO 2024/124233, and entitled “SYSTEM, METHOD, AND APPARATUS FOR DE-CENTERED STEERING FOR AN ELECTRO-MAGNETIC BEAM WITH SOURCE STEERING” (EXCT-0020-WO).

International Application No. No. PCT/US2023/083360 claims the benefit of and priority to U.S. Provisional Application Ser. No. 63/432,503, filed on 14 Dec. 2022 and entitled “SYSTEM, METHOD, AND APPARATUS FOR STEERING WITH BEAM DISPLACEMENT” (EXCT-0018-P02), and U.S. Provisional Application Ser. No. 63/431,544, filed on 9 Dec. 2022 and entitled “SYSTEM, METHOD, AND APPARATUS FOR STEERING WITH BEAM DISPLACEMENT” (EXCT-0018-P01).

International Application No. No. PCT/US2023/083360 claims the benefit of and priority to U.S. Provisional Application Ser. No. 63/447,814, filed on 23 Feb. 2023 and entitled “DE-CENTERED STEERING FOR AN ELECTRO-MAGNETIC BEAM WITH SOURCE STEERING” (EXCT-0019-P01).

Each one of the foregoing applications is incorporated herein by reference in the entirety for all purposes.

### BACKGROUND

Previously known beam steering devices suffer from a number of drawbacks. Previously known devices are constrained in one or more dimensions such as steering capability (e.g., magnitude of steering deflection angle), steering efficiency (e.g., amount of the beam energy that is incident upon the target, with losses due to side lobes, vignetting losses, steering portions of the beam to undesired locations, fringing fields, and/or losses to heat within a steering device), scan speed (e.g., time to traverse a desired steering range, and/or time between steering events from one arbitrary position to another), and/or aperture size (e.g., the effective width of a beam that can be steered). Previously known devices are often configured to support one of these aspects, while sacrificing performance for other aspects. In certain embodiments, previously known devices may be formed to achieve a desired performance by adding cost (e.g., higher capability materials, actuators, or the like, and/or by adding manufacturing expense for example with a high number of small electrodes, etc.), adding weight (e.g., larger components and/or actuators), and/or increasing the footprint of the beam steering device (e.g., a larger and/or longer device to compensate for a reduced capability, to improve aperture size, and/or provide more room for larger components).

### SUMMARY

In some aspects, the techniques described herein relate to a beam steering system, including: a light cone generator (LCG) including: a fixed fiber; and a moveable lens, wherein the fixed fiber and the moveable lens are configured to generate a cone of light; and a light cone collimator/deflector (LCCD) including: a plurality of lenses, one of the plurality of lenses being downstream of other ones of the plurality of lenses, the one of the plurality of lenses including an exit aperture configured to be filled by steered light, such that a steering beam is output at the exit aperture.

In some aspects, the techniques described herein relate to a beam steering system, wherein the LCG is configured to generate a respective cone of light for each color of light to be steered.

In some aspects, the techniques described herein relate to a beam steering system, wherein the moveable lens includes a negative lens.

In some aspects, the techniques described herein relate to a beam steering system, wherein the moveable lens includes a telecentric f-theta lens.

In some aspects, the techniques described herein relate to a beam steering system, wherein: the telecentric f-theta lens includes: two moving mirrors; and two to four lenses positioned after the two moving mirrors; and a chief ray in the telecentric f-theta lens is parallel to an optical axis of the telecentric f-theta lens.

In some aspects, the techniques described herein relate to a beam steering system, including: a light cone generator (LCG) including a telecentric f-theta lens including: a moveable reflector configured to receive light from a light source; and at least three lenses configured to magnify and focus the light from the moveable reflector onto a focal point to generate a moving cone of light; and light cone collimator/deflector (LCCD) configured to receive the moving cone of light from the LCG, the LCCD including a telecentric system including a plurality of lenses, one of the plurality of lenses being downstream of other ones of the plurality of lenses, the one of the plurality of lenses including an exit aperture configured to be filled by steered light, such that a steering beam is output at the exit aperture.

In some aspects, the techniques described herein relate to a beam steering system, wherein: the telecentric f-theta lens includes an image-plane telecentric f-theta lens; and the telecentric system includes an object-place telecentric system.

In some aspects, the techniques described herein relate to a beam steering system, wherein the moveable reflector includes a fast steering mirror (FSM).

In some aspects, the techniques described herein relate to a beam steering system, wherein the moving cone of light is written by moving the FSM of the f-theta lens at the focal point.

In some aspects, the techniques described herein relate to a beam steering system, wherein the moveable reflector includes a reflective optical phased array (OPA).

In some aspects, the techniques described herein relate to a beam steering system, wherein the OPA includes a hex array including: a plurality of lenses; and a plurality of movers respectively configured to move a corresponding lens.

In some aspects, the techniques described herein relate to a beam steering system, wherein light is provided from the light source to the hex array to generate a corresponding plurality of incident beams for each f-theta steering channel.

In some aspects, the techniques described herein relate to a beam steering system, wherein the hex array is configured to provide light beams to be focused at a field lens to generate the corresponding plurality of incident beams for each f-theta steering channel.

In some aspects, the techniques described herein relate to a beam steering system, wherein a number of the plurality of lenses is one or more of 7, 19, or 37.

In some aspects, the techniques described herein relate to a beam steering system, wherein the LCG is configured to generate a respective moving cone of light for each color of light to be steered.

In some aspects, the techniques described herein relate to a method of steering light, the method including: receiving light by a fast steering mirror (FSM) integrated with an f-theta lens; generating a moving cone of light (MCL) using the FSM and the f-theta lens; magnifying displacement (MD) of the moving cone of light; and simultaneously collimating and steering rays of the magnified moving cone of light by a reverse telecentric imaging system (RTIS).

In some aspects, the techniques described herein relate to a method, wherein the collimating and steering rays includes moving a small expanding lens with respect to a large collimating lens.

In some aspects, the techniques described herein relate to a beam steering system, including: a moving cone of light (MCL) generator including a fast steering mirror (FSM) integrated with an f-theta lens, the MCL being configured to generate a moving cone of light; a collimating lens configured to collimate the moving cone of light; a magnifying lens configured to: magnify the collimated light; and then focus the magnified light on a focal plane; a plurality of lenses configured to provide a diffraction-limited performance, the plurality of lenses being spaced apart; and a reverse telecentric imaging system (RTIS) configured to simultaneously collimate and steer light output from the plurality of lenses.

In some aspects, the techniques described herein relate to a beam steering system, further including an exit aperture lens configured to be 100% filled with steered collimated light exiting the RTIS.

In some aspects, the techniques described herein relate to a beam steering system, wherein the exit aperture lens includes glass.

In some aspects, the techniques described herein relate to a beam steering system, wherein the exit aperture lens has a same size as the plurality of lenses.

In some aspects, the techniques described herein relate to a beam steering system, wherein the exit aperture lens has a slight curvature.

In some aspects, the techniques described herein relate to a beam steering system, wherein the curvature is selected to improve an optical quality.

In some aspects, the techniques described herein relate to a beam steering system, wherein the exit aperture lens includes a varifocal lens.

In some aspects, the techniques described herein relate to a beam steering system, wherein the exit aperture lens is in contact with an atmosphere.

In some aspects, the techniques described herein relate to a beam steering system, further including a target-finding lens configured to focus the steered collimated light on a target.

In some aspects, the techniques described herein relate to a beam steering system, wherein the focal plane is a virtual plane.

In some aspects, the techniques described herein relate to a beam steering system, wherein the moving cone of light, the collimating lens, and the magnifying lens constitute a magnifier of displacement (MD).

In some aspects, the techniques described herein relate to a beam steering system, wherein the RTIS is reflective, refractive, or a combination of reflective and refractive.

In some aspects, the techniques described herein relate to a system for steering beams of light, including: means for receiving light including a fast steering mirror (FSM) integrated with an f-theta lens; means for generating a moving cone of light (MCL) using the FSM and the f-theta lens; means for magnifying displacement (MD) of the moving cone of light; and means for simultaneously collimating and steering rays of the magnified moving cone of light, including a reverse telecentric imaging system (RTIS).

In some aspects, the techniques described herein relate to a system, wherein the means for collimating and steering rays includes means for moving a small expanding lens with respect to a large collimating lens.

In some aspects, the techniques described herein relate to a system, further including an exit means for providing steered collimated light from the RTIS, the exit means being configured to be filled with steered collimated light exiting the RTIS.

In some aspects, the techniques described herein relate to a system, further including a target-finding means for focusing the steered collimated light on a target.

In some aspects, the techniques described herein relate to a system, wherein the RTIS is reflective, refractive, or a combination of reflective and refractive.

In some aspects, the techniques described herein relate to an optical phase array (OPA), including: a continuous electrode; an electro-optical (EO) crystal layer on the continuous electrode, the continuous electrode directly contacting a first surface of the EO crystal layer; a plurality of conductive transparent discrete electrodes directly contacting a second surface of the EO crystal layer, opposite to the first surface of the EO crystal layer; a plurality of resistive elements respectively arranged between closely-adjacent conductive transparent discrete electrodes on the second surface of the EO crystal layer; and a plurality of resistive transparent discrete electrodes respectively arranged between further-spaced conductive transparent discrete electrodes on the second surface of the EO crystal layer.

In some aspects, the techniques described herein relate to a OPA, wherein the continuous electrode is conductive transparent or reflective.

In some aspects, the techniques described herein relate to a OPA, wherein each of the plurality of resistive elements includes at least one of: a resistive transparent discrete electrode or an insulator.

In some aspects, the techniques described herein relate to a OPA, wherein the insulator includes at least one of: glass, silicon dioxide (SiO2), indium tin oxide (ITO), or a mask material.

In some aspects, the techniques described herein relate to a OPA, wherein alternating ones of the plurality of conductive transparent discrete electrodes are configured to receive an operating voltage of Vλ or 0 V.

In some aspects, the techniques described herein relate to a OPA, wherein Vλ is 36 V.

In some aspects, the techniques described herein relate to a OPA, wherein the EO crystal layer has a thickness <about 5 μm.

In some aspects, the techniques described herein relate to a OPA, wherein the plurality of conductive transparent discrete electrodes have a thickness of about 500 nm (0.5 μm).

In some aspects, the techniques described herein relate to a OPA, wherein the plurality of resistive elements have a thickness of about 100 nm (0.1 μm).

In some aspects, the techniques described herein relate to a OPA, wherein the plurality of resistive elements have a smaller thickness than the plurality of conductive transparent discrete electrodes.

In some aspects, the techniques described herein relate to a OPA, wherein the plurality of resistive elements have a smaller width than the plurality of conductive transparent discrete electrodes.

### BRIEF DESCRIPTION OF THE FIGURES

FIG. 1 depicts an example steering system according to an embodiment of the present disclosure.

FIG. 2 depicts a physical configuration of a resistive layer Pockels cell with resets according to an embodiment of the present disclosure.

FIG. 3 depicts example embodiments including a light cone generator (LCG).

FIG. 4 depicts an example steering system according to an embodiment of the present disclosure.

FIG. 5 depicts an example steering system according to an embodiment of the present disclosure.

FIG. 6 depicts an example flowchart showing a method according to an embodiment of the present disclosure.

FIG. 7 depicts an example steering system according to an embodiment of the present disclosure.

FIG. 8 depicts an example system for generating a moving cone of light (MCL) with an f-theta lens integrated with two galvanometric mirrors according to an embodiment of the present disclosure.

FIG. 9 depicts example scanners according to embodiments of the present disclosure.

FIG. 10 depicts example scanners according to embodiments of the present disclosure.

FIG. 11 depicts examples of magnifying displacement (MD) according to embodiments of the present disclosure.

FIG. 12 depicts examples of imaging systems according to embodiments of the present disclosure.

FIG. 13 depicts examples of reverse telecentric imaging systems (RTISs) for scanners according to embodiments of the present disclosure.

FIG. 14 depicts an optical path delay (OPD) of a resistive layer with resets according to an embodiment of the present disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

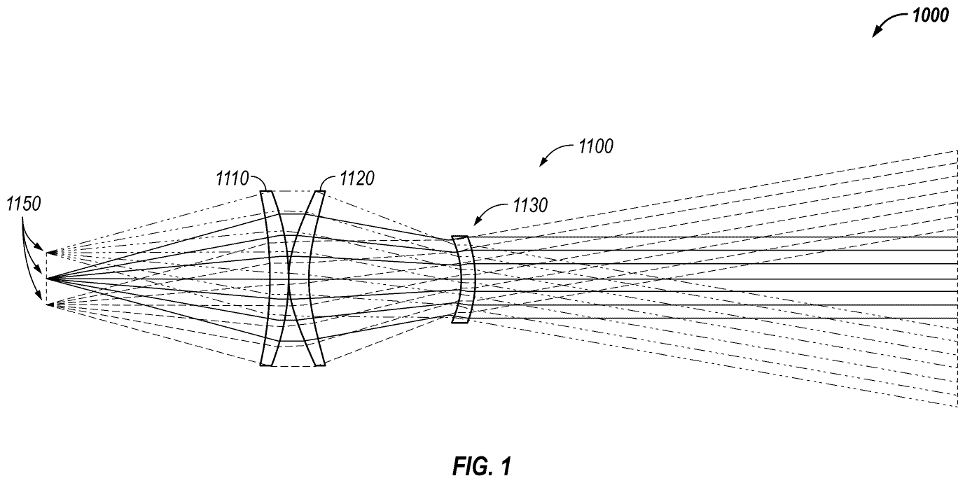

FIG. 1 depicts an example steering system according to an embodiment of the present disclosure.

An example steering system 1000 steers by separating an electro-magnetic (EM) beam into two halves, the right and left. The left half is referenced herein as the “light cone generator” (LCG), and the right half is referenced herein as the “light cone collimator/deflector” (LCCD). For the sake of clarity, the right half, or LCCD, is described first herein, and then the left half, or LCG, will be explained.

### The Right Half of the Steerer or LCCD

The right half of the steerer, or LCCD, is an object-plane-telecentric optical system including at least three lenses. Two of those three lenses are located close to each other, and the third one is located at the focal point of those two lenses to form an object-space-telecentric optical system. The third lens of the LCCD is the exit aperture. An example of an LCCD is shown in FIG. 1.

In FIG. 1, the right half of the steerer is an LCCD 1100. LCCD is an object plane telecentric system that may include, for example, three (3) lenses 1110, 1120, 1130. The third lens 1130, e.g., the furthest downstream lens, of the LCCD 1100 is the exit aperture, which is located at the focal point of the other two lenses. The lenses are depicted in FIG. 1 as physical lenses for clarity of the present description, but one or more of the lenses may be varifocal lenses (VFLs) comprising an electro-optical (EO) material with the lenses electrically written on the EO material through the application of an electric field across the respective lens.

As seen, the LCCD collimates a cone of light 1150 at the exit aperture and steers it to an angle depending on the distance between the cone point and the optical axis. The optical quality of the steered light is diffraction-limited in all angles, and the exit aperture is fully filled.

### The Left Half of the Steerer or LCG

As mentioned, besides the LCCD, the new steerer includes other optical elements located at the left half of the steerer. One function of the left half of the steerer (e.g., the LCG) is to generate one or more cones of light 1150 with single or different wavelengths, which may move mechanically or nonmechanically or may even be stationary. The moving or stationary cone(s) of light will be the input of the LCCD, and therefore, the chief ray(s) of the light cone(s) are parallel to the optical axis.

There are several methods to generate the cone(s) of the light in the LCG as the input of the LCCD. An example method is suggested as follows.

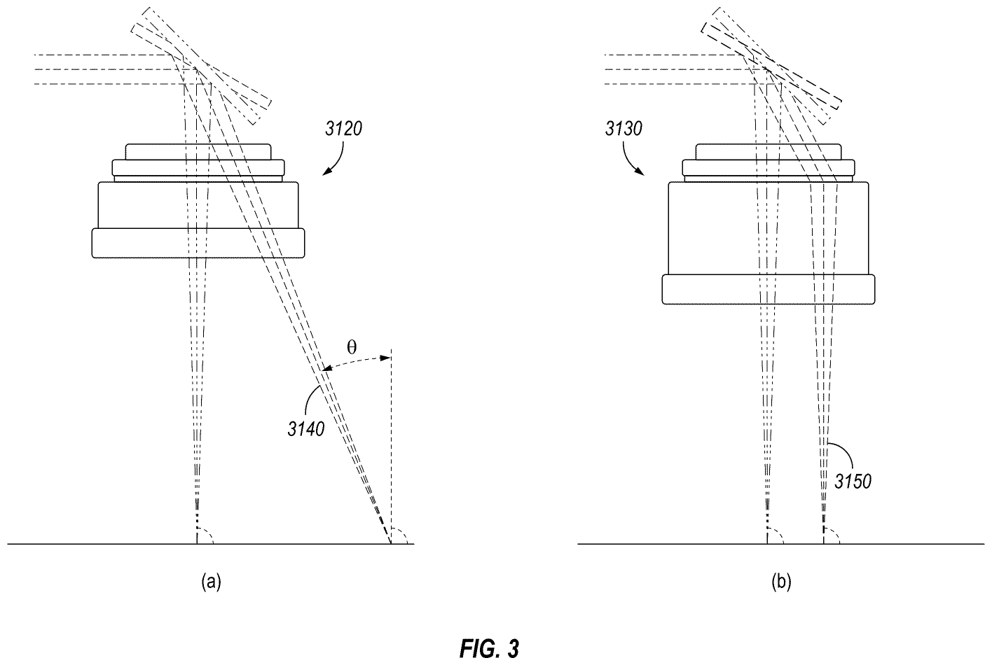

FIG. 3 depicts example embodiments including a light cone generator (LCG).

FIG. 3 illustrates an example embodiment including an LCG to generate a moving cone of light as the input of the LCCD. The example arrangement, shown in FIG. 3, part (a), which may include a standard scan lens 3120, may provide a monostatic aperture suitable for transmission and receiving, and/or may implement a faster steering system.

In another example, shown in FIG. 3, part (b), a telecentric f-theta lens 3130 may be used to write a moving cone of light in x-y axes. Instead of moving a fiber and a small negative lens together, a moving cone of light in the LCG as the input of the LCCD can be generated by the telecentric f-theta lens 3130.

An f-theta lens 3130 may include two small moving mirrors (or lenses), one for the x-axis and one for the y-axis, and two to four lenses sitting after those mirrors (or lenses). The chief ray in a telecentric f-theta lens 3130 is parallel to the optical axis. FIG. 3 compares a telecentric and a non-telecentric (e.g., standard) f-theta lens.

In the FIG. 3 example, part (a) illustrates a non-telecentric f-theta lens 3120, and part (b) illustrates a telecentric f-theta lens 3130. In FIG. 3, part (a), the chief ray 3140 may have a telecentricity error, which may be up to a maximum angle θ. In FIG. 3, part (b), the chief ray 3150 may be fully telecentric.

A telecentric f-theta lens is a lens in which the height of the chief ray at the image plane is calculated as the focal length (f) times the field angle (theta). If the chief ray of a f-theta lens is also parallel to the optical axis, at the image plane, it means the angle of the chief ray at the image plane is always zero (0), and this specific f-theta lens is called a “telecentric f-theta lens.” As can be seen by steering the light to hit the f-theta lens in different locations, because the rays out of the f-theta lens are parallel, the output is like the output of an expanding lens that is moved.

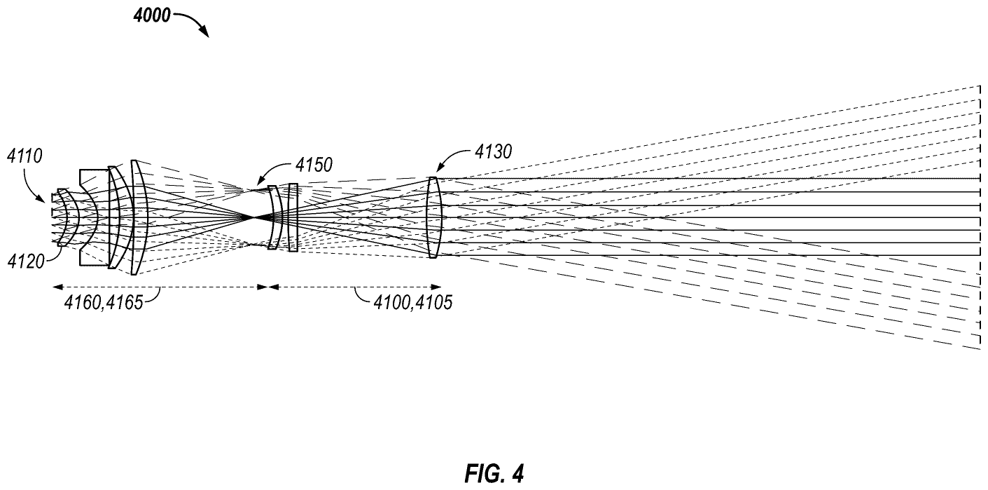

FIG. 4 depicts an example steering system according to an embodiment of the present disclosure.

An example beam steering system including a four-element telecentric f-theta lens as the LCG and a telecentric three-lens system as an LCCD is shown in FIG. 4. In the example of FIG. 4, a steering system 4000 may include a four-element telecentric f-theta lens 4165 as the LCG 4160 and a telecentric three-lens system 4105 as the LCCD 4100. The LCCD 4100 may be an object-place telecentric system. The LCG 4160 may be an image-plane telecentric f-theta lens.

In the steering system 4000, a light input 4110 from a light source may be sent to a small fast steering mirror (FSM) 4120. In the steering system 4000, only the small fast steering mirror (FSM) 4120 of the f-theta lens may move. Movement of the beam from the fiber may be performed by a mechanically moving FSM, or by an electrically written FSM (e.g., using a reflective OPA) of the f-theta lens at the focal point 4150. The third lens 4130 of the LCCD 4100 is the exit aperture.

The steering speed of the steering system 4000 can be very fast when an f-theta lens 4165 is used as an LCG 4160 to write a moving cone of light. That is because the small mirror in the f-theta lens 4165 can be tilted much faster than displacing the fiber and the negative lens together in the x and y axes. Besides, using an f-theta lens makes it possible to start with a small, collimated beam in free space. Therefore the steerer can be used as the transmitter and receiver in a monostatic aperture.

Again, experimental results showed that the beam steered at all angles can be coma-free and diffraction-limited.

Additionally, or alternatively, instead of mechanically tilting a mirror in the LCG part of the system, a reflective optical phased array (OPA) can be used to increase the speed of the steerer to MHz instead of Hz or kHz. An OPA may be utilized for one or more of the light cones generated. Due to the configuration of the beam steerer, instead of requiring a large OPA to steer light of a large beam, a small OPA can be used. As a non-limiting example, instead of requiring a 15 cm OPA to steer a 15 cm beam, an example embodiment according to the present disclosure may use a 1 cm OPA to steer a 15 cm beam of light.

### Comparing the Two Above Options for Generating the Cone(s) of Light in the LCG

Example benefits of generating a moving cone of light by using a telecentric f-theta lens as the LCG may include one or more of the following aspects:

(1) Tilting the mirror can be done much faster by off-the-shelf movers. Therefore, the steering speed may be much faster.

(2) Because the light source can be a small free space collimated beam, the steerer can work as a transmitter and receiver. As such, this new steerer can be employed in both monostatic and bistatic designs.

(3) The telecentric f-theta lens can be purchased off the shelf. Therefore, the overall cost of the system may be lower.

Example drawbacks of generating a moving cone of light by using a telecentric f-theta lens as the LCG include one or more of the following aspects:

(1) The overall system will have more lenses and potentially more back reflections. However, with a suitable coating, the back reflections can be minimized.

(2) There may not be more than one moving cone of light with this LCG. Therefore, the overall system with such an LCG may be single-threaded.

A decentered lens steering system according to an example embodiment has been introduced in the present disclosure. This steering system may include a light cone generator (LCG) and a light cone collimator/deflector (LCCD). The following eight example benefits are present relative to previously known steering systems:

(1) The steering and expanding of the light are done simultaneously. This means that if a 5 mm beam was given and the goal was to steer a 50 mm light to 10 degrees, one would not steer the 5 mm beam to 100 degrees first and then expand it to 50 mm to get the 50 mm light steered to 10 degrees. In contrast, one would expand the light to 50 mm, and at the same time, one would steer it to 10 degrees.

(2) Unlike previously-known mechanical steerers, such as Risley prisms, in which large optics are moving, only small optics are being displaced or tilted in mechanical versions of example embodiments of the present disclosure. With regard to Option 2 for the LCG, only a tiny mirror is tilted to perform the steering.

(3) Zero or very small nonlinearity, unlike other mechanical steerers like Risley prisms. If an f-theta lens is used as LCG, the off-axis-ness of the light cone is linear to the tilt angle of the mirror.

(4) It can be easily integrated with an OPA to steer nonmechanically. The small tilting mirror and/or the small moving negative lens can be written nonmechanically by OPA. Therefore, a steerer according to an example embodiment can steer the light nonmechanically.

(5) The maximum displacement of the small negative lens is not limited to the radius of the negative lens. In conventional decentered lens systems, the maximum displacement is limited to the radius of the lens. In example systems of the present disclosure, the displacement can be much larger than the radius of the small negative lens, and therefore, a wider deflection angle can be achieved for a given F-number (F#).

(6) Unlike conventional decentered lens systems, the exit aperture will be fully filled with light. The exit aperture of a steerer according to an example embodiment may be 100% filled, no matter what type of LCG is used and how many moving or stationary cones of lights are generated. Having a fill factor of one makes a narrower beam with minimum intensity going to the side lobes at the far field.

(7) Optical quality will be coma-free and diffraction-limited at all angles. A decentered lens steerer according to an example embodiment will be coma-free, unlike any other previously-known decentered lens systems. The optical quality of a system according to an example embodiment is diffraction-limited, unlike previously-known high capability mechanical or nonmechanical steerers. Previously known fast-steering mirrors have a diffraction-limited steering quality, but are limited to less than a 1-inch aperture and are capable of steering to only a few degrees. Having a diffraction-limited steered beam makes the beam diverging angle minimum, and therefore the range of the system will be much longer.

(8) A steerer according to an example embodiment can be multi-threaded. Unlike any other previously-known steerer, a steering system according to an example embodiment can independently steer more than one beam with a diffraction-limited optical quality and a fill factor of 1.

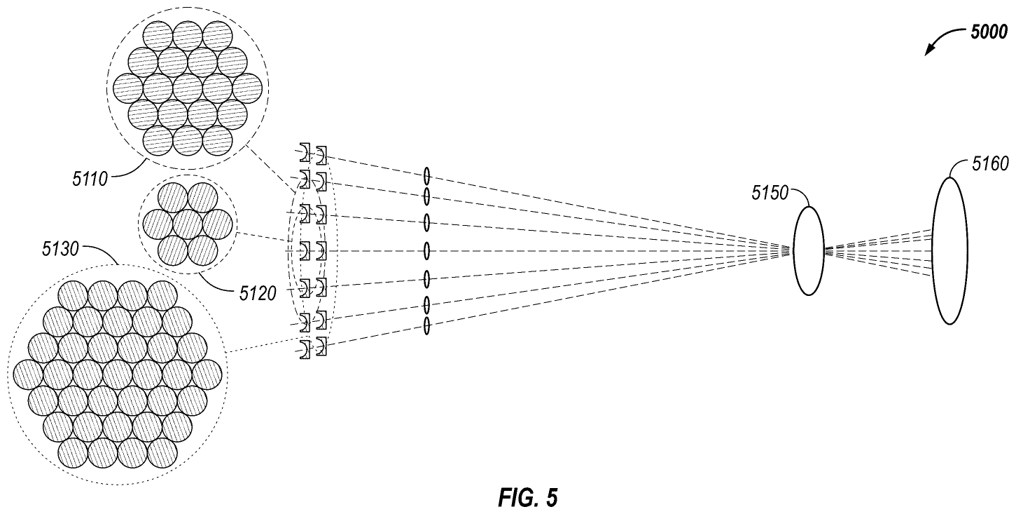

FIG. 5 depicts an example steering system according to an embodiment of the present disclosure.

Another example embodiment includes multiple threads (e.g., is multi-threaded), or beams, being independently steered. The multiple beams could be arranged in a hex fashion, as shown in FIG. 5.

FIG. 5 is an example steering system 5000 showing arrangements with multiple beams steered independently. Array 5110 is a hex 19 array of movers and lenses. Array 5120 is a hex 7 array of movers and lenses. Array 5130 is a hex 37 array of movers and lenses. Each array 5110, 5120, 5130 may steer light to a field lens 5150.

Beams can be provided through an array arranged to have multiple incident beams provided to each f-theta steering channel, for example using a hex array, e.g., arrays 5110, 5120, 5130, as shown. The lenses of each array may be positioned to steer a corresponding EM beam to an appropriate f-theta steering channel. The multiple beams may be available for steering, but may be provided selectively, with any one or more of the beams provided at any given time during operation. In certain embodiments, the lenses of the hex array may be moved to further adjust steering, and/or the lenses of the hex array may be rotated—for example, to discrete rotation angles, such as with a stepper motor or other actuator, and/or rotated quickly (e.g., in a spinning arrangement), where the source EM beam may be provided at selected times, for example when lenses of the array are at selected positions.

FIG. 5 shows example steering system a telecentric f-theta lens 5160 on the right. Light may enter at an angle, but may then exit perpendicular to the telecentric f-theta lens 5160. An example steering system may image a transmissive embodiment. An example steering system may image a transmissive hex array of steering elements, for example, space fed optical phased arrays.

The illustrated example embodiments depict transmissive optical elements that steer, but the elements could also be reflective. If they are reflective, then care should be taken to not have one element block the path of another element. Any transmissive or reflective optical element that can steer light could be in the illustrated hex 7 positions (and/or any positions of the example arrangements of the array for the specific embodiment). The geometry is not restricted to hex patterns. If hex patterns are used, then multiple circles of hex elements, e.g., a hex number of 7, 19, 37, etc., may be used. Transmissive approaches may be easier to conceptualize, so using a transmissive space-fed OPA may be an easy approach to conceptualize.

### The Exciting Technology (ET) Scanner: a Coma-Free Decentered Lens System

Generally, an example scanner may be based on a decentered lens system including a small negative lens moving in front of a group of larger lenses or mirrors. The small negative lens, which can be either an actual negative lens or a virtual one written nonmechanically by an optical phased array or mechanically by an f-theta lens, generates a moving cone of light in front of a group of larger optical elements. Conceptually the easiest way to envision making this moving cone of a light is a moving small negative, or expanding, lens. The light is steered as the result of decenteredness between the small negative lens and the group of larger refractive or reflective optical elements.

The decenteredness in an ET steerer is magnified by a dual telecentric system including two lenses to reduce the required displacement per steered angle and steer to a wider angle, but at the same time, the cone angle must be increased by the same factor of magnification to steer the beam with the desired size.

Generally, all conventional decentered lens systems suffer from coma effects because of the off-axis-ness. That is why using them for long-range applications has been impossible, thanks to their wide divergence angle. The example ET scanner is the only decentered lens steerer that is coma-free and may have no other types of aberration like distortion. A reason for the ET scanner being aberration free is the larger refractive or reflective or catadioptric group of optical elements located in the front of the moving cone of light, generated by either an actual moving glass negative lens or a virtual negative lens written by an OPA or an f-theta lens, is the reverse of a telecentric imaging system with an object at infinity.

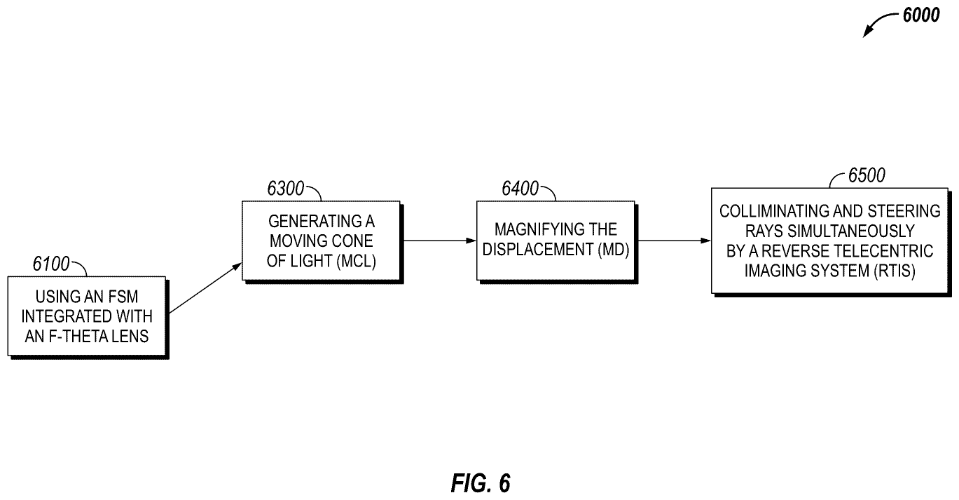

FIG. 6 depicts an example flowchart showing a method according to an embodiment of the present disclosure.

FIG. 6 is a flowchart showing a method 6000 of steering light in an example ET scanner. In operation 6100, an FSM integrated with an f-theta lens may be used to cause a moving cone of light to be generated. In operation 6300, the moving cone of light (MCL) may be actually generated. Operation 6400 may include magnifying the displacement (MD). Operation 6500 may include collimating and steering rays simultaneously by a reverse telecentric imaging system (or reverse of a telecentric imaging system) (RTIS). In other words, an example ET scanner may include three subsystems: a moving cone of light (MCL) generator, a magnifier of displacement (MD), and the reverse of a telecentric imaging system (RTIS).

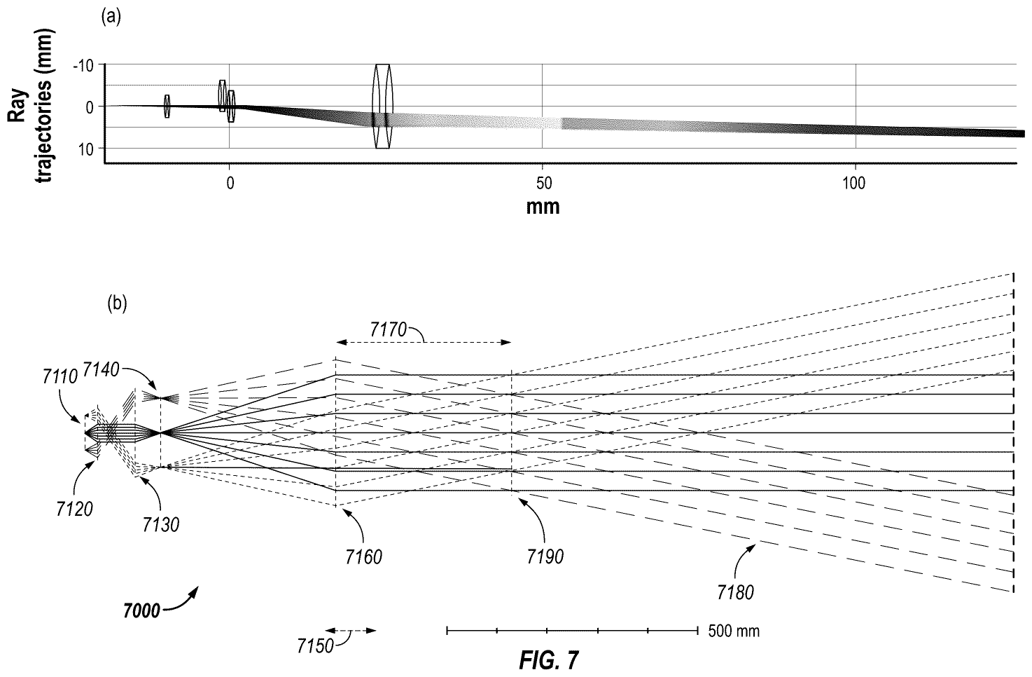

FIG. 7 depicts an example steering system according to an embodiment of the present disclosure.

With the ET scanner a small expanding lens is moved with respect to the large collimating lens. This expands the beam and steers at the same time. The example of FIG. 7 illustrates two expanding lenses, one for each dimension or steering axis. Equation 1 shows the angular deflection.

$${θ}_{i} = {tan}^{- 1} ( \frac{M {Δ}_{i}}{{f}_{n}} ) , \qquad ( 1 )$$

Magnification is inside the equation. In certain embodiments, a two-stage ET scanner can scan to larger angles by making a virtual displacement. In the two-stage steering approach, the amount of displacement is expanded virtually, allowing steering to a larger angle within a compact steering system. This may make the system longer. In the two-stage steering, the virtual displacement causes steering, rather than a real displacement. A magnifying element provides an effective displacement that may be greater than 1 times the original, and may be an integer or a fractional multiple, e.g., 1.2 or 2 times the original. A “magnification” less than 1 may be referred to as “demagnification,” which may be less desirable for certain applications, but is possible. Demagnification reduces the available magnitude of steering, but may nevertheless be utilized, for example to improve steering precision and/or to otherwise manage the optical quality of the steered beam.

FIG. 7 illustrates a paraxial presentation of an example ET scanner 7000. The example ET scanner 7000 may provide two-stage steering. In the example ET scanner 7000, a moving cone of light (MCL) 7110 may be generated by an FSM integrated with an f-theta lens, which may be an MCL generator. The moving cone of light 7110 may pass through a collimating lens 7120 to be magnified by a magnifying lens 7130, and then to be focused on a focal plane 7140, which may be a virtual plane. The moving cone of light 7110, the collimating lens 7120, and the magnifying lens 7130 may constitute a magnifier of displacement (MD) 7150. There may be a plurality of lenses at 7160, which may provide a diffraction-limited performance. The plurality of lenses 7160 be spaced apart and may be not completely filled. Next may be a reverse telecentric imaging system (RTIS) 7170. The steered collimated light 7180 may exit at an exit aperture lens 7190.

In certain aspects, the exit aperture lens 7190 may be configured to be 100% filled with steered collimated light 7180 exiting the RTIS 7170. In certain aspects, the exit aperture lens 7190 may be made of glass. In certain aspects, the exit aperture lens 7190 may have a same size as the plurality of lenses 7160. In certain aspects, the exit aperture lens 7190 may have a curvature, which may be a slight curvature. A slight curvature, as utilized herein, includes any curvature that is selected to provide certain properties to the exit aperture lens 7190, for example to apply a selected convergence or divergence to the steered beam, to provide structural properties to the exit aperture lens 7190 (e.g., stiffness, impact resistance, etc.), while providing a minimal optical change, which may be accounted for throughout the layers of the steering operations, to the steered beam. In certain aspects, the curvature may be selected to improve an optical quality. In certain aspects, the exit aperture lens 7190 may include a varifocal lens. In certain aspects, the exit aperture lens 7190 may be in contact with an atmosphere. In certain aspects, the beam steering system may further include a target-finding lens configured to focus the steered collimated light 7180 on a target.

Table 1 shows how much displacement magnification will be needed to obtain a certain steering angle. Displacement magnification causes a larger virtual displacement than the real physical displacement of the moving lenses. A 5 cm diameter FSM may be used as an example. The tilt angle makes a difference in the projected area, so changes the amount of displacement magnification. In Table 1 the example includes a 5 cm diameter FSM, tilted at 12 degrees, so the total projected size is 4.9 cm. To accommodate tilting up and down, 2.45 cm may be used as the plus and minus movement of the cone of light in the example. Table 1 shows that there may be no need for any displacement magnification for the transmitter, but there may be a need to magnify the displacement for the receiver if steering is beyond ±2.8 degrees (in the example). A two-stage system may make the optical system longer. The receive optical system is already longer than the transmit optical system, because the larger aperture requires a longer focal length for a similar F#. In Table 1 an example F#may be 1. To have diffraction-limited optical quality may require more expensive optical elements than a larger F#, but for certain applications, for example a space based device, the cost difference may not be significant. The receiver displacement magnification may be from none at ±2.8 degrees, to 2.13 times for ±6 degree, to about 4.93 for ±10 degree steering. The amount of length increase may be determined by the optical design. If making the optical system reflective (e.g., the steered beam passes through the steering optics twice), the large optical element can be made lighter, e.g., using honeycomb material. That may make the system shorter, but it may have an obstruction for certain steering angles unless an off-axis approach is used. An off-axis approach may complicate the design even beyond a standard reflective optical system. Another trade-off is the complexity of the optical system versus the complexity of the large mirror. A more complex optical system can reduce the required complexity of the larger aperture. The example system is not a standard optical telescope, and accordingly certain trade-offs relevant to telescopes, such as the field of view of a telescope relating to its cost, do not apply.

TABLE 1
Example equired Displacement Magnification for the Transmit and Receive Apertures (cm)

| | | focal | Steering | FSM Tilt | Available | Required | Required |
|---|---|---|---|---|---|---|---|
| Diameter | | length | angle | angle | dispacment using | displacement | displacement |
| (cm) | F# | (cm) | (deg) | (deg) | a 5 cm FSM (cm) | (cm) | magnification |
| 49.9 | 1 | 49.9 | 2.8 | 12 | 2.45 | 2.44 | 1.00 |
| 49.9 | 1 | 49.9 | 4 | 12 | 2.45 | 3.48 | 1.42 |
| 49.9 | 1 | 49.9 | 6 | 12 | 2.45 | 5.21 | 2.13 |
| 49.9 | 1 | 49.9 | 8 | 12 | 2.45 | 6.92 | 3.96 |
| 49.9 | 1 | 49.9 | 10 | 12 | 2.45 | 8.62 | 4.93 |
| 12.5 | 1 | 12.5 | 6 | 12 | 2.45 | 1.30 | 0.53 |
| 12.5 | 1 | 12.5 | 8 | 12 | 2.45 | 1.73 | 0.99 |
| 12.5 | 1 | 12.5 | 10 | 12 | 2.45 | 2.16 | 1.23 |
| 6.25 | 1 | 6.25 | 6 | 12 | 2.45 | 0.65 | 0.27 |
| 6.25 | 1 | 6.25 | 8 | 12 | 2.45 | 0.87 | 0.50 |
| 6.25 | 1 | 6.25 | 10 | 12 | 2.45 | 1.08 | 0.62 |

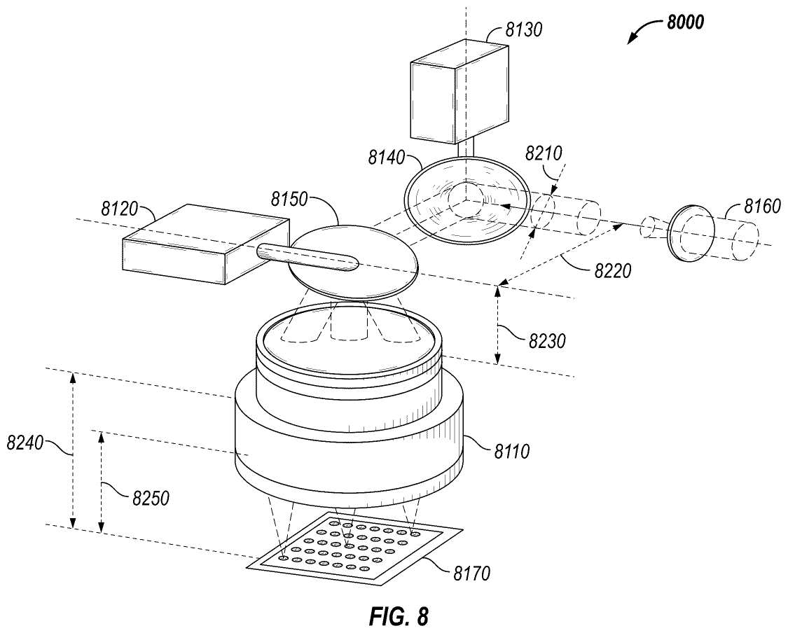

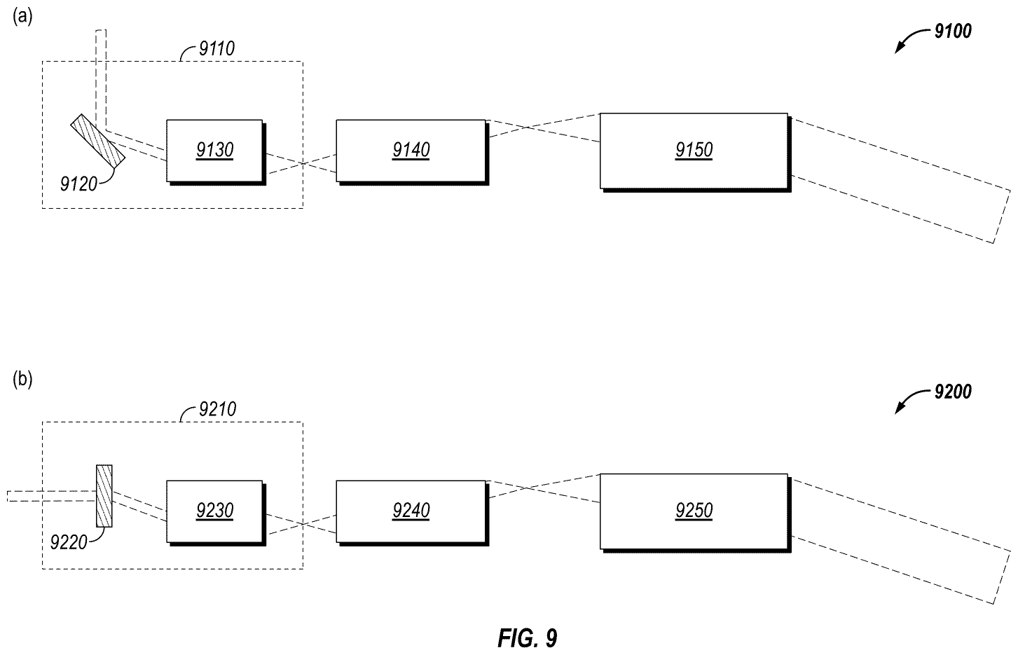

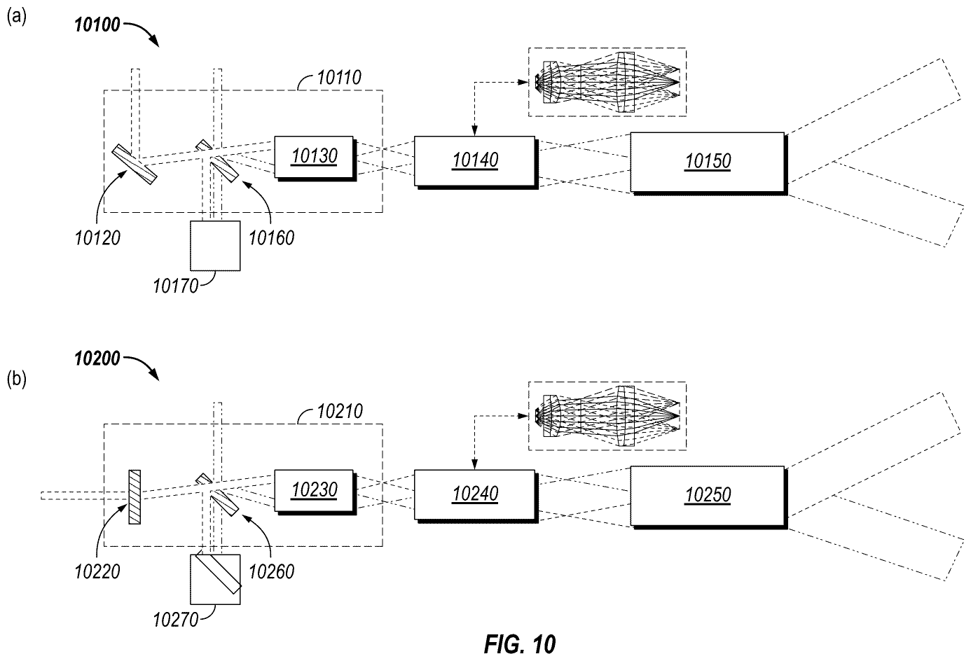

FIG. 8 depicts an example system for generating a moving cone of light (MCL) with an f-theta lens integrated with two galvanometric mirrors according to an embodiment of the present disclosure, which may be a subsystem for a steering system such as that depicted in FIG. 7. FIG. 9 depicts example scanners according to embodiments of the present disclosure. FIG. 10 depicts example scanners according to embodiments of the present disclosure.

The moving cone of light (MCL) can be generated by an f-theta lens integrated with two small galvanometric (also referred to as “Galvo” or “Galvano” herein) mirrors, e.g., one for the x-axis and one for the y-axis, as shown in FIG. 9.

FIG. 8 is a schematic view illustrating an example system 8000 for generating an MCL with an f-theta lens integrated with two Galvo mirrors. The system 8000 may include an f-theta lens 8110, two Galvano scanners 8120, 8130, first Galvano mirror 8140, second Galvano mirror 8150, an aperture mask 8160, and a scanning area 8170. The scanning area 8170 is depicted to illustrate aspects of the beam moving capability of the system 8000. In certain embodiments, for example when the system 8000 forms a part of another system such as in FIG. 7, the scanning area 8170 will not be present, and the next steering layer within the system 7000 would be the recipient of the moved beams from the f-theta lens 8110. The aperture mask may form an entrance pupil diameter (e.g., effective diameter) 8210. There may be a Galvano mirror separation distance 8220 defined between the first Galvano mirror 8140 and the second Galvano mirror 8150, and a mirror-to-lens separation distance 8230 defined between the second Galvano mirror 8150 and the f-theta lens 8110. The f-theta lens 8110 may have an effective focal length 8240 and a back working distance 8250 to the scanning area 8170 (and/or to the next steering layer).

Generating an MCL with an f-theta lens may have the following major benefits:

(1) The cone of light can be displaced very fast. Therefore, the steering bandwidth will be much higher.

(2) The Galvo mirrors can be replaced with reflective OPAs to steer the light nonmechanically or in a hybrid way (see FIG. 9).

(3) In the case of “nonmechanical and mechanical hybrid beam steering”, the mirror in the Galvo is replaced with a reflective OPA. Galvo moves the OPA mechanically to coarsely point the beam and stops. Then, the voltages are applied to the reflective OPA to finely point the light or scan nonmechanically within a smaller angle.

(4) By replacing the Galvo mirrors with dichroic mirrors or polarization beam splitters, the ET scanner can independently steer multiple beams with different wavelengths or polarizations (see FIG. 10).

FIG. 9 illustrates two example embodiments of ET scanners. In FIG. 9, part (a), the Galvo mirrors of the F-theta lens in the MCL generator subsystem can be replaced by a reflective OPA to steer the light nonmechanically with an ET scanner. In FIG. 9, part (a), an example ET scanner 9100 may generate a moving cone of light (MCL) 9110 by reflecting light 9120 with a Galvo mirror or a reflective OPA into an f-theta lens 9130. The example ET scanner 9100 may then magnify the displacement (MD) at 9140, and then pass the magnified light through the reverse of a telecentric imaging system (RTIS) 9150. As shown in FIG. 9, part (a), if an f-theta lens 9130 generates the MCL 9110, a reflective OPA may replace the Galvo mirror of the f-theta lens at 9120. Therefore, the ET scanner can be embodied as a completely nonmechanical device, with the only displacer being a reflective OPA under the voltage. Another alternative may be to use a transmissive OPA positioned before the f-theta lens as a way to have the beam enter the f-theta lens in a different location nonmechanically, as shown in FIG. 9, part (b). In FIG. 9, part (b), an example ET scanner 9200 may generate a moving cone of light (MCL) 9210 by transmitting light through a transmissive OPA 9220 into an f-theta lens 9230. The example ET scanner 9200 may then magnify the displacement (MD) at 9240, and then pass the magnified light through the reverse of a telecentric imaging system (RTIS) 9250. As another option, a mechanical mover can mechanically displace the reflective OPA under no voltage to point the light to a target coarsely. Then, the mechanical mover may stop, and the OPA may be under a modulated voltage to either point the light finely to the target or scan very quickly within a small angle. Alternatively the mechanical mirror could still be moving, in addition to the fine steering motion from the reflective OPA. The latter approach is called hybrid steering because the light is first pointed coarsely to the target mechanically, and then points finely to the target nonmechanically, or an area within a smaller angle is scanned nonmechanically with very high bandwidth.

FIG. 10 illustrates two embodiments showing that the Galvo mirrors of the F-theta lens in the MCL generator subsystem can be replaced by dichroic mirrors or polarization beam splitters to steer multiple beams independently. In FIG. 10, scanner 10100, an example ET scanner 10100 may generate a moving cone of light (MCL) 10110 by reflecting light with a Galvo mirror or a reflective OPA (10120) into an f-theta lens 10130. The example ET scanner 10100 may then magnify the displacement (MD) at 10140, and then pass the magnified light through the reverse of a telecentric imaging system (RTIS) 10150. As shown in FIG. 10, scanner 10100, if an f-theta lens 10130 generates the MCL 10110, a reflective OPA may replace the Galvo mirror of the f-theta lens at 10120.

In FIG. 10, scanner 10200, an example ET scanner 10200 may generate a moving cone of light (MCL) 10210 by transmitting light through a transmissive OPA 10220 to an f-theta lens 10230. The example ET scanner 10200 may then magnify the displacement (MD) at 10240, and then pass the magnified light through the reverse of a telecentric imaging system (RTIS) 10250.

As shown in FIG. 10, multiple beams with individual beams having, for example, different wavelengths or polarization can be steered by an ET scanner independently if the Galvo mirror of the f-theta is replaced with a dichroic mirror or a polarization beam splitter (e.g., 10160 in scanner 10100, or 10260 in scanner 10200. Partially transparent optical elements could also be used to provide independent beams for steering. In the ET scanners 10100, 10200 of FIG. 10, each color of light may be independently steered.

Using a dichroic reflector or a beam splitter (10160, 10260) with the f-theta lens to generate MCLs, a fraction of the light will be transmitted instead of reflected, and therefore it may be absorbed in a beam dump (e.g., 10170 in part (a) or 10270 in part (b)), as shown in FIG. 10. However, the coating of the dielectric reflector (10160, 10260) may be adjusted to have a little to no intensity dumped into the beam dump 10170, 10270.

An ET easy OPA can be placed on the surface of the FSM, to do the fine angle steering precisely and quickly. In FIG. 10, a moving expanding lens is effectively created, but by using a fast scanning mirror (FSM), an F-theta lens, and a reverse telecentric imaging system. This generates an expanding cone of light, similar to what an expanding lens generates, but it does so with no optical aberration, and using an FSM, which can steer faster than the mechanical movement of a lens up and down, or side to side. The output of the initial portion of the optical system is an expanding cone of light that moves up and down, or side to side. This expanding cone of light then propagates through the rest of the optical system. This optical system can be coma-free and diffraction-limited, and can move as fast as the fast steering mirror. Also, we can place a small angle, reflective, ET easy optical phased array on the surface of the FSM. The small angle OPA will do very fast, very precise, steering. Placing an easy ET OPA on the FSM should be demonstrated for risk reduction.

### Subsystem 2: Magnifying the Displacement (MD)

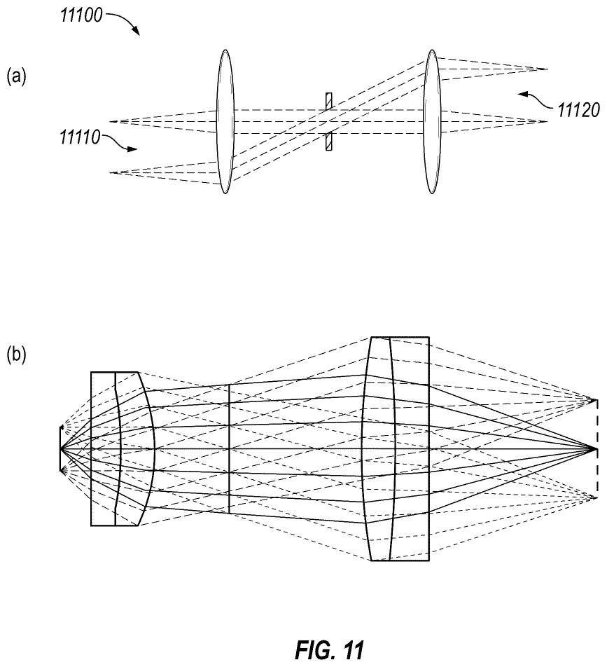

FIG. 11 depicts examples of magnifying displacement (MD) according to embodiments of the present disclosure.

FIG. 11, part (a) illustrates a general representation of an example light cone displacement magnifying system, which is based on a dual-telecentric imaging system; and part (b) illustrates an actual magnifier of a light cone displacement (MD). The displacement of the light cone in an ET scanner may be magnified to decrease the required light cone displacement per steering angle. Therefore, the light can be steered to a wider angle with less or minimum required light cone displacement. The magnifier of the light cone displacement (MD) may be a dual-telecentric imaging system 11100, as shown in FIG. 11, part (a). An example dual-telecentric imaging system 11100 may include an entrance pupil 11110 and an exit pupil 11120.

As shown in FIG. 11, by magnifying the light cone displacement, the light cone angle decreases by the same magnification factor, resulting in a smaller deflected beam size. Therefore, to reach the desired deflected beam size, the input light cone angle must be wide enough so the desired beam size can still be achieved after decreasing the light cone angle by the displacement magnifier system. If a negative lens generates the cone of light, the numerical aperture (NA) of that small negative lens should be large enough. If an f-theta lens generates the light cone, the focal length of that f-theta lens should be short enough to make the light cone angle wide enough at the input of the displacement magnifier system. The magnification factor may not be infinity because the NA of the small negative lens has a maximum to avoid total internal reflection, and also the focal length of the f-theta lens has a minimum to maintain diffraction limited optical quality.

### Subsystem 3: The Reverse of a Telecentric Imaging System (RTIS)

In certain embodiments, features to support optical quality of the steered beam that is coma-free or even diffraction-limited for wide angles and wide apertures include the group of larger reflective or refractive, or catadioptric optics located after the light cone displacement magnifier is, in fact, the reverse of a telecentric imaging system (RTIS) with the object an infinity. This means that, instead of the parallel rays within the field of view (FOV) getting focused on the image plane, the cone of light gets collimated and steered within the FOV.

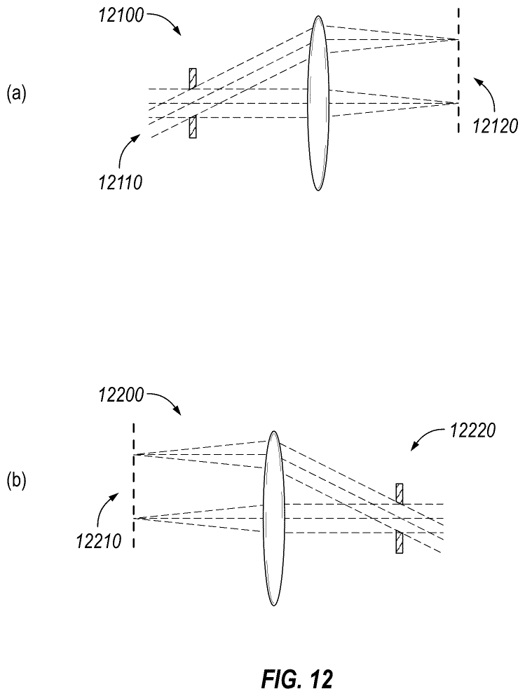

FIG. 12 depicts examples of imaging systems according to embodiments of the present disclosure.

FIG. 12, part (a) is a schematic representation of an image plane telecentric imaging system with an object at infinity. FIG. 12, part (b) illustrates that the imaging system shown in part (a) may be reversed to form an RTIS for an ET scanner. In FIG. 12, part (a), an example image plane telecentric imaging system 12100 may include an entrance pupil 12110 and an exit pupil 12120, with chief rays perpendicular to an image plane. In FIG. 12, part (b), an example reversed image plane telecentric imaging system 12200 may include an entrance pupil 12210 and an exit pupil 12220, with chief rays perpendicular to an object plane.

The RTIS is an important part of the ET scanner. To design an optimal RTIS, first, an image plane telecentric imaging system with an object at infinity (see FIG. 12, part (a)) should be designed and optimized to be diffraction limited. Then, that imaging system should be reversed (see FIG. 12, part (b)) to form an RTIS subsystem for an ET scanner.

Because, at least in theory, an image plane telecentric imaging system with an object at infinity, even with a large aperture and wide FOV, can be optimally designed to be free of geometrical optics aberrations, including coma, distortion, chromatic aberration, and spherical aberration, within a specific FOV, the RTIS, which is the reverse of that system, can be aberration-free. Therefore, if the moving cone of light (MCL) is generated aberration-free, the collimated light steered to all angles within the FOV by an ET scanner can be aberration-free and will have the minimum divergence angle.

The ET scanner that steers light with the minimum (diffraction limited) divergence angle will be the only aberration-free decentered lens system. So, the ET scanners can be used in long-range applications; it was not possible to use a decentred lens-based steering system before.

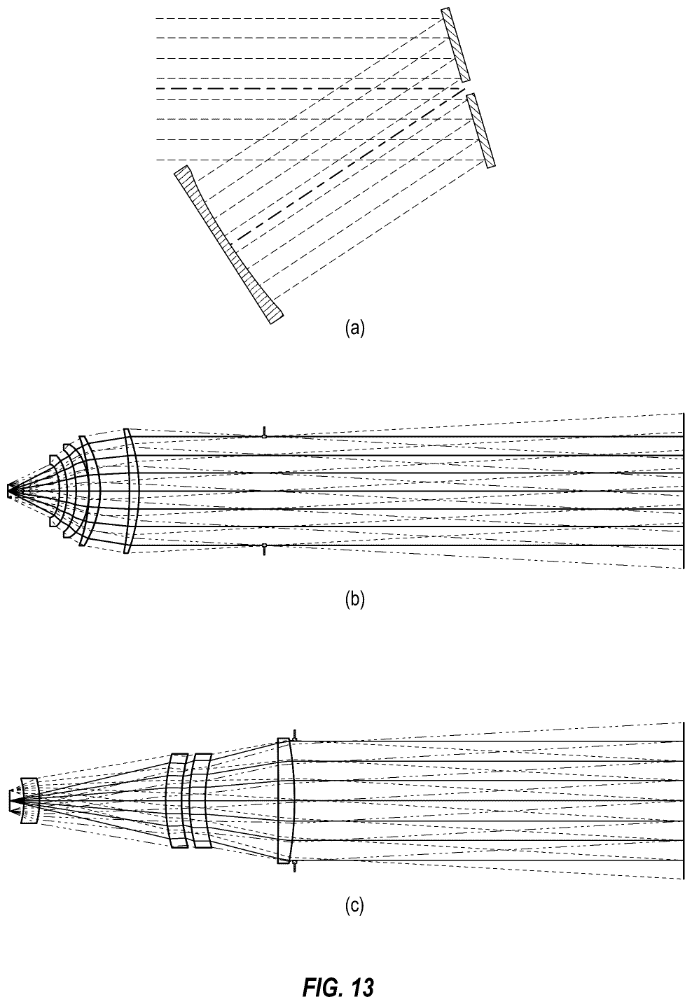

FIG. 13 depicts examples of reverse telecentric imaging systems (RTISs) for scanners according to embodiments of the present disclosure.

FIG. 13 shows some examples of RTISs for ET scanners in different applications. As mentioned, an RTIS may be reflective (e.g., mirrors), as shown in FIG. 13, part (a); refractive (e.g., lenses), as shown in FIG. 13, part (b); or a combination of reflective and refractive surfaces, as shown in FIG. 13, part (c). An RTIS can also be catadioptric, which is also a combination of reflective and refractive surfaces, which is not shown in the examples illustrated in FIG. 13.

### Non-Mechanical Beam Steering System

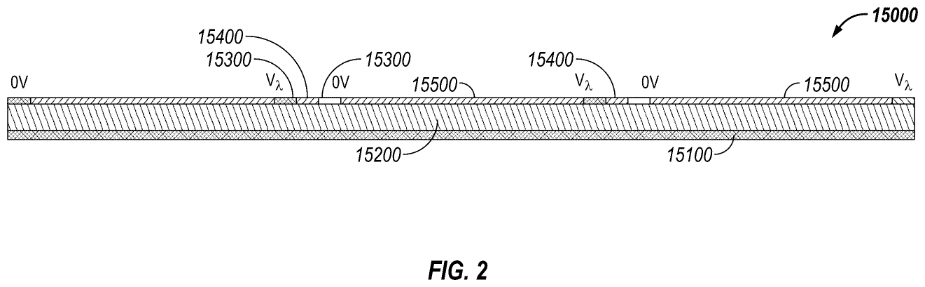

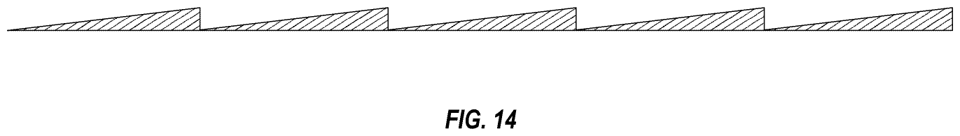

FIG. 14 depicts an optical path delay (OPD) of a resistive layer with resets according to an embodiment of the present disclosure. FIG. 2 depicts a physical configuration of a resistive layer Pockels cell with resets according to an embodiment of the present disclosure. The embodiments of FIGS. 14 and 2 provide an example of an “easy OPA” as recited herein.

A small angle easy ET optical phased array (OPA) may be placed on the surface of an FSM. A resistive layer may be between a pair of electrodes, and will have modulo 2π resets. The system may only use two drive voltages. For example, for a 5 cm easy OPA at 1.5 μm, it may use 58 electrode pairs to steer ±0.1 degrees. The system may use less than 30 V, instead of more than 1000 V in other systems.

Every time a full wavelength of optical path difference is reached, there may be a reset to zero path difference, and the voltage increase may start again (modulo 2πn). This may be much simpler to build, and may work with high efficiency for small angles. This may be referred to as a “fixed period” OPA. In certain embodiments, the reset may occur at a multiple of 2π delay, for example at 4π, 6π, etc. It will be seen that the voltage of such a system will be higher—for example 60V, 90V, etc., although still significantly lower than the maximum voltage in other systems.

FIG. 14 illustrates an optical path delay (OPD) of a resistive layer with resets. In order to steer efficiently with a fixed period reset, rectangular optical path delay (OPD) sections may be placed below each triangle. FIG. 2 illustrates a physical configuration of a resistive layer Pockels cell with resets. The OPD sections may add additional voltages. For large angles, fringing fields may be an issue, but for the small angles considered here the loss in efficiency due to fringing fields may be minimal, small, and/or negligible. One design issue will however be how close the resistive ramps may be to one another. A gap between resistive ramps may cause a steering loss.

In FIG. 2, an optical phase array (OPA) 15000 may include a continuous electrode 15100, an electro-optical (EO) crystal layer 15200 on the continuous electrode 15100, the continuous electrode 15100 directly contacting a first surface of the EO crystal layer, a plurality of conductive transparent discrete electrodes 15300 directly contacting a second surface of the EO crystal layer 15200, opposite to the first surface of the EO crystal layer 15200, a plurality of resistive elements 15400 respectively arranged between closely-adjacent conductive transparent discrete electrodes 15300 on the second surface of the EO crystal layer 15200, and a plurality of resistive transparent discrete electrodes 15500 respectively arranged between further-spaced conductive transparent discrete electrodes 15300 on the second surface of the EO crystal layer 15200.

In certain aspects, V_{λ} may be, for example, 36 V. A resistive element, e.g., a resistive transparent discrete electrode or an insulator, may be between closely-adjacent conductive transparent discrete electrodes. A resistive transparent discrete electrode may be between further-spaced conductive transparent discrete electrodes. The plurality of resistive elements have a smaller width than the plurality of conductive transparent discrete electrodes. An insulator between the conductive transparent discrete electrodes may be, e.g., glass, silicon dioxide (SiO₂), or indium tin oxide (ITO), and may have a smaller thickness than the conductive transparent discrete electrodes. The EO crystal layer may be, for example, up to 5 μm thick. The conductive transparent discrete electrodes may have a thickness of, for example, 500 nm (0.5 μm). The resistive element, e.g., an insulator, may have a thickness of, for example, 100 nm (0.1 μm). A mask may be used as the insulator, and a mask may increase heat generation. A larger distance between the V_{λ} electrode and the 0 V electrode may lead to greater inefficiency in the reset. If the 0V electrode is under the V_{λ} electrode, e.g., “castle” style, the reset may be more efficient and fringing fields may be reduced or eliminated, but that may be only for a linear EO material. Also, fabrication may be more expensive for the castle-style electrodes. The selected distance should avoid arcing. In selecting between a resistive transparent discrete electrode or an insulator, although the reset may be less predicable with an insulator, the distance may be smaller with the insulator, which increases the reset efficiency.

Various active EO materials may be considered, for example, KTN ((KTa₁₋ₓNbₓO₃)), PMN-PT (lead magnesium niobate-lead titanate), and BaTiO₃ (barium titanate). PMN-PT may be used in the Kerr effect region. Both KTN and BaTiO₃ may be used in the linear region, using the Pockels effect. PMN-PT is a ceramic, and may cause steering of both polarizations. The single crystal form of KTN or BaTiO₃ may be used, and these may only steer one polarization at a time. For a polarized laser, that may not have a major effect on transmit. On receive there may be some loss because the target will partially depolarize the return, e.g., by 20%. KTN may be grown as a ceramic instead of as a single crystal. A ceramic KTN may steer both polarization just like would happen with ceramic PMN-PT. Table 2 shows required voltages using PMN-PT, using 5×10⁻¹⁶ as an EO coefficient.

TABLE 2
Required half wave voltages for PMN-PT

| Material | n | R (m²/V²) | λ (μm) | d (μm) | Voltage |
|---|---|---|---|---|---|
| PMN-PT | 3.23 | 5.E−16 | 1.55 | 1 | 9.6 |
| PMN-PT | 3.23 | 5.E−16 | 1.55 | 2 | 13.6 |
| PMN-PT | 3.23 | 5.E−16 | 1.55 | 3 | 16.6 |
| PMN-PT | 3.23 | 5.E−16 | 1.55 | 4 | 19.2 |
| PMN-PT | 3.23 | 5.E−16 | 1.55 | 5 | 21.4 |

One issue may be how thin the PMN-PT can be made. This may be the case when using the Kerr effect. Using the Kerr effect, thinner PMN-PT may require lower voltage, but that may not be the case for the linear Pockels effect. Illustrative R values used for PMN-PT in Table 2 have been determined by experimental measurements. BATI claims larger R values, resulting in lower voltages, with values anywhere from 8×10⁻¹⁶ to 28×10⁻¹⁶. These values may depend on temperature. A larger R value may allow a lower voltage for the same steering angle. Another issue may be at what temperature the system is operated, and how stable the temperature must be. Lastly, an off-the-shelf 5 cm diameter hot pressed PMN-PT ceramic may be used, but it only has a usable diameter of 4.5 cm. Table 2 shows that the required voltage will be ±16.6 volts or less with a thickness of 3 μm or less, and ±21.6 volts for 5 μm or less thickness. Because PMN-PT contains lead, the smart cut approach using ion slicing may not be preferable. A smart cut could achieve less than 1 μm thickness, but lead makes ion penetration very difficult, so a smart cut may be difficult. Ions do not penetrate lead-containing materials well.

For a linear EO effect, ferroelectric KTN or BaTiO₃ may be used. Equation 2 provides:

$$Δ n = \frac{r}{2} {n}^{3} E \qquad ( 2 )$$

for the linear electro-optical effect. To obtain the voltage required to get half wave optical path difference, OPD, λ/2, Equation 3 provides:

$$V = \frac{λ}{r {n}^{3}} . \qquad ( 3 )$$

Table 3 shows that, for the linear case, the required voltage is not dependent on material thickness.

TABLE 3
Required half wave voltage using the linear EO Effect

| Material | n | r (m/V) | λ (μm) | V_pi (Volt) | d (m) | E (V/m) | Δn |
|---|---|---|---|---|---|---|---|
| BaTiO₃ | 2.44 | 1.670E−09 | 1.55 | 63.9 | 1 | 6.39E+07 | 0.775 |
| BaTiO₃ | 2.44 | 1.670E−09 | 1.55 | 63.9 | 5 | 1.28E+07 | 0.155 |
| Ferroelectric KTN | 2.27 | 8.50E−09 | 1.55 | 15.6 | 1 | 1.56E+07 | 0.775 |
| Ferroelectric KTN | 2.27 | 8.50E−09 | 1.55 | 15.6 | 5 | 3.12E+06 | 0.155 |

BaTiO₃ may use a voltage drive of ±64 volts. KTN may have one of the best linear and quadratic EO effect, so the required voltage may be only ±15.6 volts. PMN-PT and KTN may have lower voltage requirements. An easy OPA may be close to 5 cm in diameter.

The separation of the resets may be determined by how large an angle can be steered. For non-mechanical beam steering (NMBS), it may be required, for example, to scan 256 detectors with 4 simultaneous beams, or 1024 detectors with a single beam, depending on whether NMBS is used on the receiver or not. Also, the larger aperture for scanning the receiver will require more magnification, so the system may be steered to a larger angle before magnification.

TABLE 4
NMBS scan angles, and reset sizes

| | Scan | Scan | Half | | | Electrode | OPA | | |
|---|---|---|---|---|---|---|---|---|---|
| # of | angle | angle | angle | Optical | Total half | seperation | width | # of | # of |
| elements | (radians) | (degrees) | (degrees) | Magnification | angle (deg) | (μm) | (cm) | resets | electrodes |
| 256 | 0.00032 | 0.0183 | 0.0092 | 14.12 | 0.13 | 456.0 | 5.0 | 110 | 219 |
| 1024 | 0.001279999 | 0.0733 | 0.0367 | 14.12 | 0.52 | 114.0 | 5.0 | 439 | 877 |
| 256 | 0.00032 | 0.0183 | 0.0092 | 1.77 | 0.02 | 3641.1 | 5.0 | 14 | 27 |
| 1024 | 0.001279999 | 0.0733 | 0.0367 | 1.77 | 0.06 | 910.3 | 5.0 | 55 | 110 |

In Table 4, for receiving, a reset spacing of 456 μm is needed to scan across 256 detectors with 4 simultaneous beams, and 114 μm to scan across 1024 detectors with a single beam. This may result in 219 and 877 electrodes, respectively. As such, non-mechanically steering the receiver will take more electrodes than steering just the transmitter.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure, and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

Any element in a claim that does not explicitly state “means for” performing a specified function, or “step for” performing a specified function, is not to be interpreted as a “means” or “step” clause as specified in 35 U.S.C. § 112(f). In particular, any use of “step of” in the claims is not intended to invoke the provision of 35 U.S.C. § 112(f).

Persons skilled in the art may appreciate that numerous design configurations may be possible to enjoy the functional benefits of the inventive systems. Thus, given the wide variety of configurations and arrangements of embodiments of the present invention, the scope of the invention is reflected by the breadth of the claims below rather than narrowed by the embodiments described above.

1-3. (canceled)

4. A beam steering system, comprising:
a light cone generator (LCG) comprising a telecentric f-theta lens comprising:
a moveable reflector configured to receive light from a light source;
at least three lenses configured to magnify and focus the light from the moveable reflector onto a focal point to generate a moving cone of light; and
an image-plane telecentric f-theta lens; and
a light cone collimator/deflector (LCCD) configured to receive the moving cone of light from the LCG, the LCCD comprising a telecentric system comprising an object-place telecentric system comprising a plurality of lenses, one of the plurality of lenses being downstream of other ones of the plurality of lenses, the one of the plurality of lenses comprising an exit aperture configured to be filled by steered light, such that a steering beam is output at the exit aperture.

5. (canceled)

6. The beam steering system of claim 4, wherein the moveable reflector comprises a fast steering mirror (FSM).

7. The beam steering system of claim 6, wherein the moving cone of light is written by moving the FSM of the telecentric f-theta lens at the focal point.

8. The beam steering system of claim 4, wherein the moveable reflector comprises a reflective optical phased array (OPA).

9. The beam steering system of claim 4, wherein the OPA comprises a hex array comprising:
a plurality of lenses; and
a plurality of movers respectively configured to move a corresponding lens.

10. The beam steering system of claim 9, wherein light is provided from the light source to the hex array to generate a corresponding plurality of incident beams for each f-theta steering channel.

11. The beam steering system of claim 10, wherein the hex array is configured to provide light beams to be focused at a field lens to generate the corresponding plurality of incident beams for each f-theta steering channel.

12. The beam steering system of claim 9, wherein a number of the plurality of lenses is one or more of 7, 19, or 37.

13. The beam steering system of claim 4, wherein the LCG is configured to generate a respective moving cone of light for each color of light to be steered.

14-15. (canceled)

16. A beam steering system, comprising:
a moving cone of light (MCL) generator comprising a fast steering mirror (FSM) integrated with an f-theta lens, the MCL being configured to generate a moving cone of light;
a collimating lens configured to collimate the moving cone of light;
a magnifying lens configured to:
magnify the collimated light; and
then focus the magnified light on a focal plane;
a plurality of lenses configured to provide a diffraction-limited performance, the plurality of lenses being spaced apart; and
a reverse telecentric imaging system (RTIS) configured to simultaneously collimate and steer light output from the plurality of lenses.

17. The beam steering system of claim 16, further comprising an exit aperture lens configured to be 100% filled with steered collimated light exiting the RTIS.

18. The beam steering system of claim 17, wherein the exit aperture lens comprises glass.

19. The beam steering system of claim 17, wherein the exit aperture lens has a same size as the plurality of lenses.

20. The beam steering system of claim 17, wherein the exit aperture lens has a slight curvature.

21. The beam steering system of claim 20, wherein the curvature is selected to improve an optical quality.

22. The beam steering system of claim 17, wherein the exit aperture lens comprises a varifocal lens.

23. The beam steering system of claim 17, wherein the exit aperture lens is in contact with an atmosphere.

24. The beam steering system of claim 17, further comprising a target-finding lens configured to focus the steered collimated light on a target.

25. The beam steering system of claim 16, wherein the focal plane is a virtual plane.

26. The beam steering system of claim 16, wherein the moving cone of light, the collimating lens, and the magnifying lens constitute a magnifier of displacement (MD).

27. The beam steering system of claim 16, wherein the RTIS is reflective, refractive, or a combination of reflective and refractive.

28-43. (canceled)
